(19) United States
(12) Patent Application Publication
(10) Pub. No.: US 2026/0368925 A1
(43) Pub. Date: Nov. 19, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Kenshi SAITO, Kanagawa (JP)

(21) Appl. No.: 19/558,556

(22) Filed: Mar. 6, 2026

(30) Foreign Application Priority Data
Mar. 21, 2025 (JP) 2025-046974

(51) Int. Cl. G06T 7/73; G06T 7/246; G06T 7/90

(52) U.S. Cl. CPC G06T 7/75; G06T 7/251; G06T 7/90; G06T 2207/10016; G06T 2207/10024; G06T 2207/20084; G06T 2207/30196

(57) ABSTRACT

An image processing apparatus is provided with an input image acquisition unit that performs acquisition of input images; and a tracking unit that performs detection of information relating to a region of an object and occlusion of the object based on a plurality of the input images from different times, and also performs tracking of the object based on results of the detection.

### BACKGROUND OF THE INVENTION

### Field of the Invention

The present disclosure relates to an image processing apparatus, an image processing method, and a storage medium, and in particular to a technology for tracking a specific subject within an image.

### Description of the Related Art

As a technology for tracking a specific subject within an image, technologies that use luminance and color information, template matching, and the like exist. In addition, in recent years, technologies that use Deep Neural Networks (referred to below as DNNs) have been gaining attention as high precision tracking technologies.

Non-patent publication 1 (“Fully Convolutional Siamese Networks for Object Tracking”, arXiv 2016) is one method for tracking a specific subject within an image, and in this, an image in which the tracking subject appears, and an image that will become the search range are each input into Convolutional Neural Networks (referred to below as a CNN) that have the same weight. In addition, the position within the image for the search range in which the tracking target exists is specified by calculating the cross-correlation for the feature amounts that have been obtained from each of these CNNs.

In addition, recently, vision transformers that apply the structure of a transformer to image recognition (non-patent publication 2 (Dosovitsky et al, An Image is Worth 16×16 words: Transformers for Image Recognition at Scale)) have emerged, and these are causing even greater increases in image recognition precision. In contrast to such tracking methods being able to accurately identify the position of a tracking target, in a case such as when an object that is similar to the tracking target overlaps with the tracking target on the screen, it is easier for an error to occur in which the wrong target is tracked.

In order to avoid this error, as is represented by the method of U.S. Pat. No. 10,185,877, there is a method that creates a histogram from the color features and the depth information for the region for the detection object, and determines whether or not the object is being occluded by searching for changes and the like in the histogram. In addition, as is disclosed in Japanese Unexamined Patent Application, First Publication No. 2022-019339, there is also a method that determines whether or not an object is being occluded by utilizing a DNN.

However, in the method that is disclosed in Japanese Unexamined Patent Application, First Publication No. 2022-019339, the detection of the object and the determination of the occlusion state are performed by different mechanisms, and the occlusion state is utilized in the matching costs for candidates, and therefore, there is the problem that the precision of the detection itself cannot be increased.

However, for example, in matches for team sports and the like, there are many cases in which a target is occluded by a different object, and it is difficult to continue to accurately detect an object that has been occluded when using the conventional methods. Although there are also methods that differentiate objects by using the traveling direction of the objects and the like, such as Japanese Unexamined Patent Application, First Publication No. 2013-219531, in a case in which a plurality of objects are traveling in the same direction while being image captured by a hand-held camera that is not secured in place, it is difficult to achieve precision.

### SUMMARY OF THE INVENTION

The image processing apparatus according to one embodiment of the present disclosure comprises an input image acquisition unit that performs acquisition of input images; and a tracking unit that performs detection of information relating to a region of an object and occlusion of the object based on a plurality of the input images from different times, and also performs tracking of the object based on results of the detection.

Further features of the present disclosure will become apparent from the following description of embodiments with reference to the attached drawings.

### BRIEF DESCRIPTION OF THE DRAWINGS

FIG. 1A, and FIG. 1B are schematic diagrams that explain the principles the First Embodiment of the present disclosure.

FIG. 2 is a diagram showing an example of a hardware configuration of image processing apparatus 1 that tracks a tracking target in the First Embodiment.

FIG. 3 is a functional block diagram showing a configurational example of functional blocks of the image processing apparatus 1 of the First Embodiment.

FIG. 4 is a flowchart showing an example of processing procedures that executed by the image processing apparatus 1 of the First Embodiment.

FIG. 5A, and FIG. 5B are diagrams showing examples of results of tracking processing of the image processing apparatus 1 of the First Embodiment.

FIG. 6A, and FIG. 6B are diagrams showing examples of results of the tracking processing of the information processing apparatus according to the First Embodiment.

FIG. 7 A to C are diagrams explaining other examples of occlusion information in the First Embodiment.

FIG. 8 is a functional block diagram showing a configurational example of functional blocks of the image processing apparatus 1 according to a Second Embodiment.

FIG. 9 A to C are diagrams showing examples of results of tracking processing of the image processing apparatus 1 according to the Second Embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

### First Embodiment

In the First Embodiment, an explanation will be given of a function that detects and tracks a person from a video image, and a plurality of still image frames that have been continuously image captured. Note that although the applied range of the First Embodiment does not limit the category of the object that is the detection/tracking target, in the present embodiment, an explanation will be given that limits the target to a person.

In the First Embodiment, the tracking of a person is performed by detecting the same person that appears in continuous frames. In the present embodiment, in particular, an explanation will be given of an example in which the image capturing of a sports event, and the like is imagined, where the clothing, movement directions, and the like of the persons are similar, and proximity and intersection of the subjects occur with a high frequency.

In such a case, it becomes easy for errors in tracking to occur if persons for which the visible features such as the position and color of the subject are close are made the same person between each frame. In this context, such errors are referred to as erroneous tracking.

In addition, the First Embodiment will focus on occlusion states for times when objects overlap as seen from the photographer, and erroneous tracking will be inhibited, and the tracking precision will be increased by using information relating to what kind of occlusion states have occurred for the tracking subject in past frames in the tracking of objects.

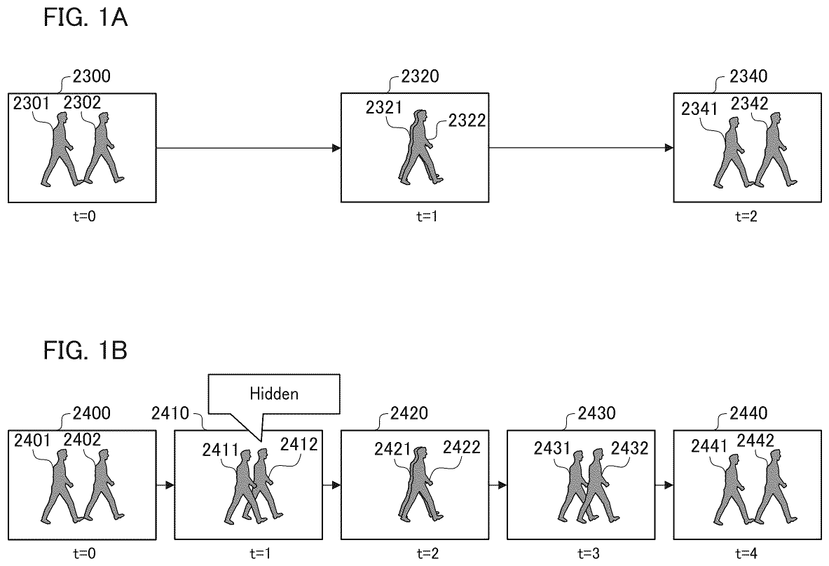

FIG. 1A, and FIG. 1B are schematic diagrams for explaining the principles of the First Embodiment of the present disclosure. In FIG. 1 A, and FIG. 1 B, the appearances of the persons such as their clothing, postures, and the like, as well as their traveling directions are made the same. A case is assumed in which a person 2302 is being tracked in the video image frame 2320 of FIG. 1A.

Conventionally, in such a case, if for example, persons such as a person 2321, and a person 2323 overlap in the video image frame 2320 for the time t=1, it becomes difficult to determine which of the person 2321 and the person 2322 the person 2302 who is being tracked has become.

Therefore, during the video image frame 2340 for the time t=2, it becomes such that it cannot be determined which of the person 2341 and the person 2342 should be tracked.

In contrast, if the objects are observed by focusing on the occlusion state before and after these subjects intersected, when the person 2402 is being tracked in the video image frame 2420 during the time t=1 in FIG. 1 (B), then it is understood that in the video image frame 2410 for the time t=2, there is an occlusion state caused by a different subject.

That is, it is understood that in the video image frame 2410 for the time t=2, the person 2402 is being hidden by the person 2401. Therefore, it can be determined that in the video image frame 2420 for the time t=3, the person 2402 is the person 2421 on the far side, and it becomes possible to prevent erroneous tracking.

In addition, it is possible to understand that the person 2402 is the person 2431 and the person 2441, and to perform correct tracking by understanding the occlusion state history for the times t=3 to 4 after this in the same manner.

Note that in relation to the above-described determination of the occlusion state, information for which the generation cost thereof is high, such as the use of a special sensor for obtaining 2.5 dimensional depth images, optical flow, and the like are not absolutely necessary.

That is, when subjects overlap with one subject on the front side and one on the far side, it is possible to understand this as a pattern recognition problem for what kind of appearances become easy to occur under conditions in which continuous changes to the appearance occur. Above, a summary of the principles of the First Embodiment have been explained.

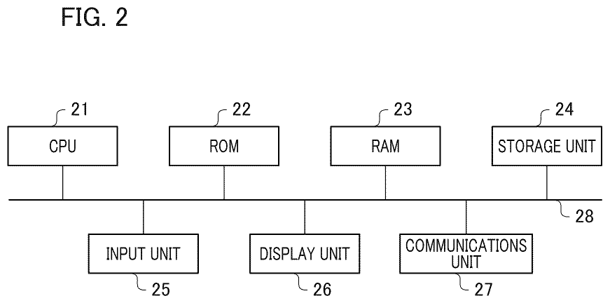

FIG. 2 is a diagram showing a configurational example of hardware for t image processing apparatus 1 that tracks tracking subjects in the First Embodiment. The control of the entirety of the image processing apparatus 1 is performed by a CPU 21, which serves as a computer, executing a control-use computer program that is stored on a ROM 22.

A RAM 23 temporarily stores each type of data from each configurational element. In addition, the RAM 23 expands the computer program, and makes this a state in which the computer program can be executed by the CPU 21. A storage unit 24 stores data that will become a processing target in the present embodiment, and also stores data that will become a tracking target.

It is possible to use an HDD, a flash memory, each type of optical media, and the like as the medium for the storage unit 24. An input unit 25 is configured by a keyboard/touch panel, a dial, and the like, receives inputs from the user, and is used when setting the tracking target.

A display unit 26 is configured by a liquid crystal display and the like, and displays the subjects and tracking results to the user. In addition, the image processing apparatus 1 is able to communicate with other apparatuses such as an image capturing apparatus and the like via a communications unit 27. Note that 28 is a bus to which 21 to 27 are connected.

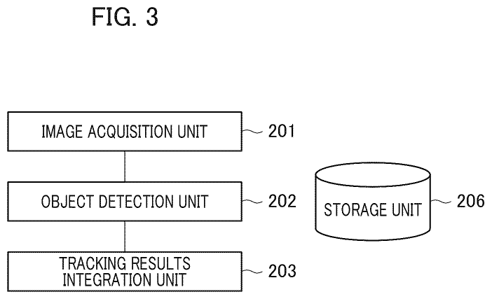

FIG. 3 is a functional block diagram showing a configurational example of the functional blocks of the image processing apparatus 1 of the First Embodiment. Note that a portion of the functional blocks that are shown in FIG. 3 are realized by a CPU and the like serving as a computer that is included in an information processing apparatus executing a computer program that has been stored on a memory serving as a storage medium.

However, it may also be made such that a portion or the entirety of these functional blocks are configured by hardware. As the hardware, an application specific circuit (ASIC), a processor (a reconfigurable processor, a DSP), and the like can be used.

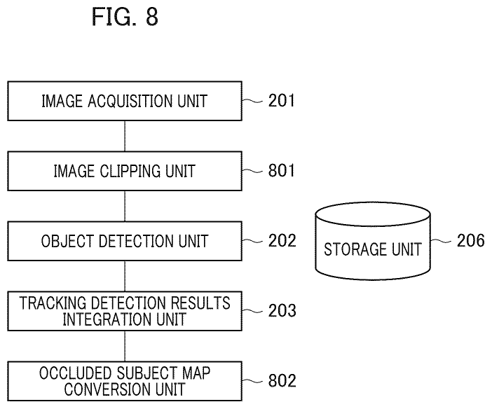

In addition, each of the functional blocks that is shown in FIG. 3 does no need to be housed in the same body, and may also be configured by separate apparatuses that are connected to each other by signal paths. Note that the above explanation relating to FIG. 3 also applies to FIG. 8 in the same manner.

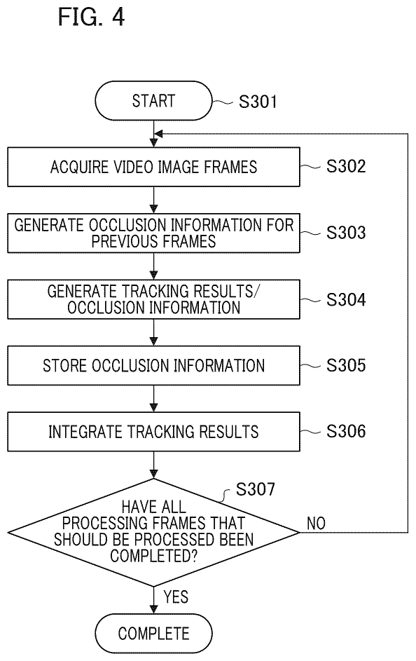

In addition, FIG. 4 is a flowchart showing an example of processing procedures that are executed by the image forming apparatus 1 of the First Embodiment. Note that the operations for each step of the flowchart in FIG. 4 are performed in order by a CPU and the like that serves as a computer inside of the information processing apparatus executing the computer program that has been stored on the memory.

In the following explanation, the notation of the processes (steps) will be abbreviated by adding an S to the beginning of each process (step). However, the information processing apparatus does not necessarily need to perform all of the processes that are explained in this flow chart.

First, during S301, the processing flow for FIG. 4 is begun by turning the power source for the image processing apparatus 1 on. Next, the processing from S302 to S307 is repeatedly executed in frame cycles. Note that the processing for S302 to S307 is processing that is repeatedly performed for each image of the video image frames.

During S302, an image acquisition unit 201 acquires each image frame for video images and continuous still images that have been captured of persons. Note that the image acquisition unit 201 may also acquire images that have been captured by an image capturing apparatus that is separate from the information processing apparatus but that has been connected to the information processing apparatus, and the image acquisition unit 201 may also acquire images that have been stored on the storage unit 24. Note that step S302 functions as an input image acquisition step (input image acquisition unit) for acquiring input images.

Next, during S303, an occlusion states for a previous frames is acquired. That is, an occluded subject map for the occlusion state of the tracking target that was determined and saved during a previous N frame caused by different subjects is acquired. although in the present embodiment, for example, N=3, this may also be any frame.

Next, tracking results/occlusion information are generated. That is, an object detecting unit 202 tracks a specific person while detecting the occlusion state for that person from the images that were acquired during step S301 and the occluded subject map for the previous N frame. It is sufficient if the method that is disclosed in non-patent publication 1, and the like is used as the method for tracking the object from among the images.

In this context, S304 functions as a tracking step (tracking means) for detecting information relating to a region of an object and occlusion of the object based on the plurality of input images for different times and for tracking the object based on the detection results.

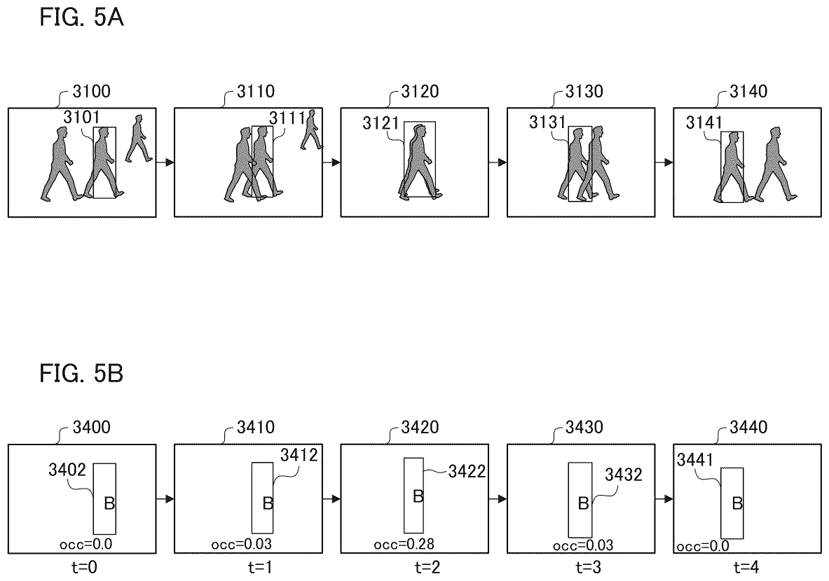

FIG. 5(A), and FIG. 5 (B) are diagrams showing examples of results for tracking processing for the image forming apparatus 1 of the First Embodiment, and the results of tracking the target subject from within the images is shown in FIG. 5 (A). The rectangular boxes 3101, 3111, 3121, 3131, and 314 in FIG. 5 (A) are bounding boxes (written below as BB) that show the object position that has been tracked.

The specific calculation method will be explained below in the explanation of the tracking results integration for S306. In this context, it is determined whether or not the occlusion state for the person is an occlusion state in which each person is overlapping with a different person, and in a case in which these are overlapping, whether the subject is on the far side and whether the subject is on the front side, and the results of these determinations are output for each region as a score for the occlusion state.

This is one type of recognition task for semantic segmentation, and is performed by using a well-known method such as the method of non-patent publication 3 (“Chen et. Al, DeepLab: Semantic Image Segmentation with Deep Convolutional Nets, Atrous Convolution, and Fully Connected CEFs, arXiv, 2016”), and the like. FIG. 5 (B) is a diagram showing estimation results for an occluded subject score for each box. The estimation results for the occluded subject score will be explained below.

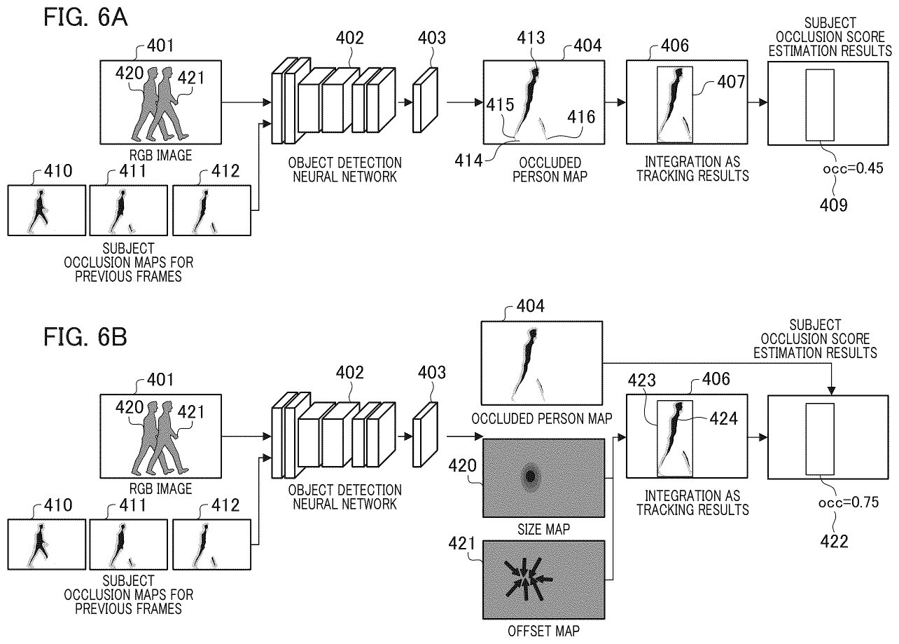

FIG. 6 (A), and FIG. 6 (B) are diagrams showing examples of results for tracking processing of the image processing apparatus 1 of the First Embodiment. FIG. 6 (A) shows a schematic diagram and an example of results for this processing. A neural network 402 that determines an occlusion region is a functional unit that uses the CNN that is disclosed in non-patent publication 1, and the like.

An RGB image 401, and occluded subject maps 410, 411, and 412 for the previous N frame are input. Therefore, the neural network 402 outputs the results of estimating whether or not this person is in the images and further estimating whether or not this person has been occluded as the occluded subject map 404 via a likelihood score map 403 for the occluded object. The likelihood score map 403 for the occluded object will be explained below.

In this manner, in the present embodiment, the tracking unit estimates which regions of the input images for different times an object shown in an input image for a specific time is present in, and outputs the results thereof as the occluded subject map 404. Note that the information relating to occlusion in the present embodiment includes the occluded subject map relating to the occluded object, and the occluded subject map represents the likelihood of a region in which the subject can be seen.

In a case in which the occluded subject map 404 has been estimated to be region other than the tracking subject, 0 is output as the likelihood score, and in a case in which the occluded subject map has been estimated to be the tracking target region, a likelihood score of 1 is output. It is thereby possible to output a map in which the area becomes smaller in proportion with the extent to which the tracking target is hidden, and to display this as the hidden state. Note that a case is shown in which it has been estimated that this is a region for a person who has been occluded with a likelihood score that is high enough that this is a black region in the occluded subject map 404.

However, in the case of the first video image frame, there are no previous frames, and therefore, an initial occluded subject map that will be described below is input as the occlusion state for the previous N frame. Learning is performed in advance such that the neural network 402 is able to make outputs such as this for the input images. Note that this learning will be explained below.

Note that the occluded subject map 404 that has been shown in FIG. 6 shows one example of an ideal output state as the estimation results, and there are also cases in which erroneous determinations, and noise in which a portion of a hand or a leg is missing are included in the actual determination results.

Note that in addition to the RGB image 401, it may also be made such a 2.5 dimensional depth image is separately acquired by using a dedicated sensor, and the like, In this case, the 2.5 dimensional depth image that has been acquired using the dedicated sensor, and the like, is for example, learned and recognized by being input into the neural network 402 together with the 3 channel RGB image 401.

Note that the 2.5 dimensional depth image is a 1 channel 2 dimensional image, and the values for each pixel that configures the image include, for example, distance information for between the sensor and the subject. It is thereby also possible to make the information for the occlusion region more precise.

In this context, the generation method for the above-described initial occluded subject map will be explained. The initial occluded subject map is calculated according to the occlusion state of the tracking target in the first video image frame. In a case in which the tracking subject is not occluded, and also in a case in which the region information for the tracking subject cannot be obtained, a map in which all of the regions are made 0 is used.

In addition, in a case in which the occlusion state for the first video image frame can be obtained in advance, the occluded subject map may also be created based on this occlusion state, and a copy for the amount of N frames can be created and input. As one example, a method is explained in which in the first video image frame, the initial occlusion map is created by using segmentation for the tracking target.

First, segmentation information for the tracking target for the first frame is calculated in advance using the method that has been disclosed in non-patent publication 2, and the like, and the map for the segmentation that has been obtained is copied for N amount of frames. The segmentation map that has been copied is used as the initial occluded subject map for the occluded subject map.

During S305, the occluded subject map that was obtained during S304 is stored in the storage unit 206. During S306, the tracking results are integrated. That is, a tracking results integration unit 203 calculates the tracking results 407 based on the occlusion information that has been obtained from the tracking results and the occluded subject map.

In a case in which a bounding box for direct tracking results is calculated from the occluded subject map, a rectangle that encircles a reacting region in the occluded subject map is made the tracking results. For example, in a case in which an occluded subject map such as 404 in FIG. 6A has been obtained, the smallest rectangle that encircles each of the upper edge 413, the lower edge 414, the left edge 415, and the right edge 416 is made a bounding box 407 for the tracking results.

Conversely, as is disclosed in non-patent publication 4 (SiamFC ++: Towards Robust and Accurate Visual Tracking with Target Estimation Guidelines), offset values (width direction/height direction) for a map in which an object detection neural network has estimated the size (height/width) of the tracking subject and the center position of the tracking subject may also be output as the map. In addition, a bounding box that also includes the occluded subject map, the size map, and the offset map may also be formed.

In addition, a bounding box that has the height/width (w, h) of a size map corresponding to a region (x,y) that is reacting in the occluded subject map, and also has a central position (x+dx, y+dy) that has been moved by exactly the offset values (dx, dy) from the position of this region may also be made the tracking results.

Using the bounding box that has been obtained as the tracking results, aggregation of the occlusion information is performed, and this is stored in order on the storage unit 206. In addition, during S306, a hidden state is determined based on the state of the occluded subject map 404 within the bounding box 407, which is the subject detection box in FIG. 6(A).

In a case in which the bounding box is calculated based on only the occluded subject map, the hidden state for the tracking subject is determined using the change amounts for the size and area of the bounding box that has been created by the occluded subject map for a previous frame.

How much an area X1 of a bounding box that is created from the occluded subject map has changed from an area X0 of a bounding box for the previous N frame is referred to as the occlusion state for the tracking subject.

Conversely, it may also be made such that the size and offset values (420, and 421 in FIG. 6 (B)) for the tracking target are estimated by a neural network 402 for object detection. In addition, in a case in which a bounding box 423 can be formed separately from the occluded subject map, the hidden state may also be determined based on the ratio of the area for the region 424, for which the score for the occluded subject map within the bounding box is 1, in comparison with the area of the bounding box 423.

That is, when the area of the bounding box 423 is made X2, and the area of the region 424, for which the score for the occluded subject map within the bounding box 423 is 1, is made X3, for example, occ=(1−X3/X2) is made the occlusion state based on the ratio of X3 to X2.

An example of the aggregation results is shown in which occ=0.45 is made the subject score value 409 in FIG. 6 (A). In addition, in FIG. 6 (B), occ=0.7 is shown as the occluded subject score value 422. In a case in which the area of 407 in FIG. 6(A) is extremely smaller than the area for the past frame in FIG. 6(A), it is determined that the occlusion score is high.

In 422 of FIG. 6 (B), the area of the region 424 of the occluded subject map is smaller than the area of 423, and therefore, the occlusion score is high. As an example of results in which the above-described processing has been performed on the input image of the previous FIG. 5, the occluded subject score for each box is shown as the estimation results, as is shown in FIG. 5 (B).

During S307, it is determined whether or not the video image frames for which processing should be performed have been completed, and in a case in which No has been determined, the processing returns to S302, and in a case in which Yes has been determined, the processing flow of FIG. 4 is completed.

In this manner, by performing S301 to S307 for each video image frame, it is possible to detect a person who is the tracking target from the video image, and as is shown in FIG. 5A, and B, to obtain tracking boxes that show where each object has moved, and occluded subject scores for each of these tracking boxes.

As has been explained above, in the First Embodiment, a region that is visible (occluded subject object region) from among the objects that are occluded was estimated as the occlusion information, which is information for the occlusion state. Various formats are considered for the output format for this occlusion information.

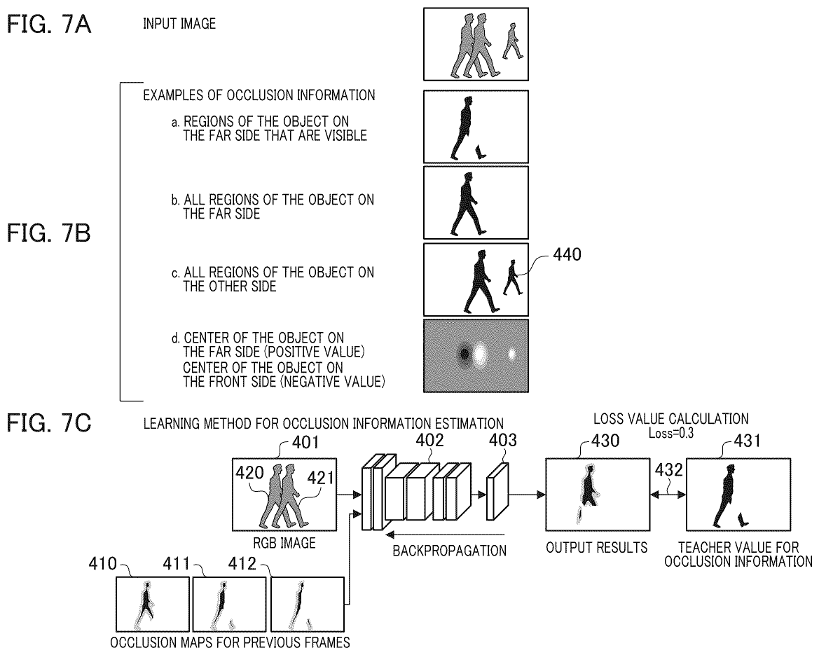

FIG. 7 A to C are diagrams explaining other examples of occlusion information for the First Embodiment. As is shown in FIG. 7B, an entire region b for an object on the far side may also be estimated, not just the visible region a for the object on the far side, based on an input image such as that in FIG. 7A.

In addition, a region c for an occluded object on the front side may also be estimated. That is, the occluded subject map may also show a likelihood relating to a region that occludes an object. In this case, in the same manner as for the region 440, estimation may also be performed by also including, as the front side region, persons who do not overlap with other objects. However, as a different mode, it may also be made such that such singular objects are not included in the region for the front side.

In addition, it may also be made such that instead of only estimating the foreground and background regions, as is done for a to c in FIG. 7 (B), the center of an object and the center of gravity position thereof are also estimated. In the same manner as the example shown in d, it may also be made such that a large positive value is estimated for regions within the vicinity of the center of the occluded subject object, and a small negative value is estimated for the vicinity of the center of the occlusion object. Note that here, the central region of the object is represented as a region with the form of a Gaussian coefficient.

In this context, how the learning is performed for the information for the occlusion state will be explained using FIG. 7C. In the same manner as the technologies in non-patent publication 3, and the like, the neural network 402 outputs the likelihood score map 403 for the occluded object based on the RGB image 401, which is an input image that has been prepared for learning (referred to below as a learning image), and the occluded subject maps 410 to 412 for past frames.

430 represents an example of results for the likelihood score map 403. Although in non-patent publication 3, and the like, the foreground region for a specific category object is estimated, in the present embodiment, a teacher value 431 for the occlusion information is provided, and learning for the neural network 402 is performed such that a map that is similar to the teacher value 431 can be obtained by estimation.

The teacher value is data that has been prepared in advance, as is shown in a to d of FIG. 7. For example, in a case in which a region such as a is learned, the visible region of the object on the far side is determined by observations of the data creator, and learning is performed by using data in which this region has been made correct.

Specifically, the likelihood score map 403 from the output results is compared with the teacher data 431, and loss value calculation 432 is performed using a well-known method such as cross-entropy, square error calculation, and the like. The weight parameter of the neural network 402 is adjusted using backpropagation and the like such that the loss value gradually decreases. Note that this processing is the same as the processing in non-patent publication 3, and the details thereof will therefore be omitted.

When doing so, it is necessary to provide a sufficient quantity of learning images and teacher values. It is costly to create a teacher value for a region of a heavy object, and therefore, CG may also be used, and the learning data may also be created by using image syntheses methods that clip and superimpose object images. The above-explained learning method becomes the learning method for the occlusion information.

Note that as in FIG. 7C, in addition to methods in which the occluded subject map for the previous frame is input into the neural network 402 in the same manner as the learning images, it may also be made such that the occluded subject map for the previous frame is input from a different layer than the RGB image 401.

As has been explained above, according to the First Embodiment, it is possible to decrease tracking failures when objects come near to each other and intersect. In particular, it is possible to decrease tracking failures caused by the intersection of objects that are similar to each other. Therefore, it is possible to provide an image processing apparatus in which it is difficult for erroneous tracking to occur even in cases in which objects that are similar to the tracking target exist in the vicinity of the tracking target.

### Second Embodiment

FIG. 8 is a functional block diagram showing a configurational example of functional blocks for the image processing apparatus 1 of the Second Embodiment. In the Second Embodiment, in addition to performing the tracking of persons and occlusion determinations in the same manner as in the First Embodiment, an image clipping unit 801, and an occluded subject map conversion unit 802 are further added to the configuration of the First Embodiment. Note that the occluded subject map conversion unit 802 functions as a coordinate conversion unit that performs coordinate conversion for the occluded subject map.

Note that in the First Embodiment, the object detection unit performs processing on the input images as is, and therefore, there are cases in which the persons who appear in the input images are small, and cannot be tracked. In this context, in the Second Embodiment, regions in which it is thought that tracking targets of the input images appear are cropped, and tracking processing is performed by using images of these regions. The cropping method is cropping the images at a size that is proportionate to the size of the tracking targets centered on the positions of the tracking targets that have been detected by the object tracking unit in previous frames.

This is because, in the First Embodiment, there are cases in which it cannot be fully perceived what kind of positional relationship the occluded subject maps that have been obtained from each video image frame have in the input images.

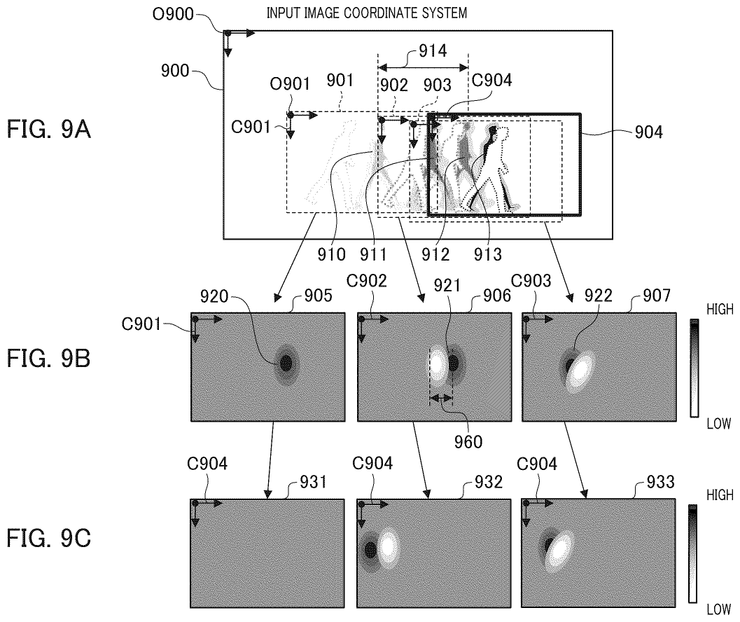

FIG. 9 (A) to (C) are images showing examples of results for tracking processing for the image processing apparatus 1 of the Second Embodiment. For example, an example will be explained in which tracking processing is performed in the object detection unit with respect to a block image 904 that has been obtained by cropping a certain region in an input image 900 such as is shown in the video image frame for FIG. 9 (A).

At this time, a case is assumed in which 905, 906, and 907 of FIG. 9 (B) have been obtained as each of the occluded subject maps from the cropped images 901, 902, and 903 from when tracking processing was performed at a time that was before the cropped image 904. Note that in the present embodiment, for the sake of simplification, the occluded subject map is made the mode that was explained in d of FIG. 7.

The occluded subject map 905 that is obtained from the cropped image 90 shows how the tracking subject is occluded on a coordinate system (referred to below as a cropped image coordinate system) C901 for which the upper left O901 of the image that has been cropped has been made the origin point.

In the same manner, occluded subject maps 906, and 907 are calculated f the cropped images 902, and 903 using a coordinate system in which the upper left in each of the cropped images is made the origin point. Note that in the present explanation, the cropped image coordinate system corresponding to the cropped image 901 is made C901, the cropped image coordinate system corresponding to the cropped image 902 is made C902, the cropped image coordinate system corresponding to the cropped image 903 is made C903, and the cropped image coordinate system corresponding to the cropped image 904 is made C904.

At this time, it is made such that the person 913 in the input image 900 has moved in positions such as 910, 911, and 912 in the previous frames. In this case, in the occluded subject map that is obtained, in the same manner as for 920, 921, and 922 of FIG. 9 (B), the positional relationships between each of the cropped image coordinate systems C901, C902, and C903 move according to the criteria from when cropping was performed.

The information relating to the movement amount (for example, the movement amount 914 in the horizontal direction for 910, and 913) for the tracking target in the input image coordinate system in which the upper left O900 of the input image 900 is made the origin point, is thereby lost. In addition, in the occluded subject map 905, only the movement amount on C901 is stored, in 906, only the movement amount on C902 is stored, and on 907, only the movement amount on C903 is stored

Therefore, in a case in which a occluded subject map that is obtained by spanning over video image frames is directly made an input into the neural network, it becomes such that an occluded subject map having the positions and movement amounts from C901, C902, and C903 is input.

It thereby becomes easy for the movement amount for the tracking target the cropped image coordinate system C904 that corresponds to 904 to become about 960 even if the movement amount for the tracking target 910 in the input image coordinate system is about 914.

In order for the neural network to infer how far from the center of the cropped image 904 the tracking subject has moved to in C904, it becomes necessary to perform learning such that the movement amount for the tracking target on C904 is calculated from the movement amounts on C901 to C903. However, in the above-described case, it is difficult to predict the movement destination of the tracking target.

In order to avoid this, in the Second Embodiment, after the occluded subject map has been converted to the input image coordinate system one time in the occluded subject map conversion unit, the occluded subject map is re-converted to the cropped image coordinate system C904 for the cropped image 904 that is input into the object detection unit. That is, the coordinate conversion unit converts the coordinates for the occluded subject map that has been obtained from an input image from a different time than the input image to the coordinates for the occluded subject map that is calculated according to the input image.

Examples of occluded subject maps for the cropped image coordinate system 904 for the cropped image 904 are shown in 931, 932, ad 933 of FIG. 9 (C). By performing conversion to the cropped image coordinate system C904 in this manner, it is possible to handle the occluded subject maps with the movement amount on C904 being preserved as is and it is possible to simplify the learning for the neural network.

In a case in which the coordinates (x′, y′) for the conversion destination the cropped image coordinate system C904 is the size of the occluded subject map for a conversion destination that has been determined in advance, for example, in which this exceeds a size that is the same as the size of the occluded subject map that is output by the object detection unit, the coordinates (x, y) from before the conversion are not substituted. In addition, in a case in which the coordinates from before conversion (x, y) in relation to the coordinates (x′, y′) for the conversion destination are coordinates that are not on the occluded subject map, 0 is substituted.

An example in which coordinate conversion has been applied to the occluded subject map that is shown in FIG. 9 (B), and this has been converted to C904 is shown in FIG. 9 (C). As is shown in FIG. 9 (C), the positions of the tracking target in the occluded subject maps 920, 921, and 922 in the cropped image coordinate systems C901, C902, and C903 can preserve the movement amount (914, and the like) in the input image coordinate system as seen from the cropped image coordinate system C904.

Therefore, according to the Second Embodiment, when a tracking target is found in the cropped image 904, it is possible to feedback how large of a movement amount this object has moved by until now to the neural network, and it is possible to realize tracking with a higher precision.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image processing apparatus and the like through a network or various storage media. Then, a computer (or a CPU, an MPU, or the like) of the image processing apparatus and the like may be configured to read and execute the program. In such a case, the program and the storage medium storing the program configure the present invention.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-046974, filed on Mar. 21, 2025, which is hereby incorporated by reference herein in its entirety.

What is claimed is:

1. An image processing apparatus comprising at least one processor;
and a memory coupled to the at least one processor, the memory storing instructions that, when executed by the at least one processor, cause the at least one processor to:
perform acquisition of input images; and
perform detection of information relating to a region of an object, and occlusion of the object based on a plurality of the input images from different times, along with tracking of the object based on results of the detection.

2. The image processing apparatus according to claim 1, wherein during the tracking, estimation is performed for what region the object that appeared in an input image from a specific time is in of an input image from a different time.

3. The image processing apparatus according to claim 1, wherein the information relating to the occlusion includes an occluded subject map relating to occlusion of the object.

4. The image processing apparatus according to claim 3, wherein the occluded subject map shows a likelihood for a region in which the object is visible.

5. The image processing apparatus according to claim 3, wherein the occluded subject map shows a likelihood relating to a region that occludes the object.

6. The image processing apparatus according to claim 3, wherein the memory stores further instructions that, when executed by the at least one processor, cause the at least one processor to:
perform coordinate conversion for the occluded subject map.

7. The image processing apparatus according to claim 6, wherein during the coordinate conversion, coordinates of an occluded subject map that has been obtained from an input image from a different time than the input image are converted to coordinates for an occluded subject map that is calculated according to the input image.

8. An image processing method comprising:
acquiring an input image; and
detecting information relating to a region of an object and occlusion of the object based on a plurality of the input images from different times, along with tracking the object based on the results of the detecting.

9. A non-transitory computer-readable storage medium storing a computer program including instructions for executing the following processes:
acquiring an input image; and
detecting information relating to a region of an object and occlusion of the object based on a plurality of the input images from different times, along with tracking the object based on the results of the detecting.
